(19) United States
(12) Patent Application Publication
(10) Pub. No.: US 2017/0124260 A1
(43) Pub. Date: May 4, 2017

(54) MEDICAL HOME TREATMENT SYSTEM

(71) Applicant: Innovative Oncology Business Solutions, Albuquerque, NM (US)

(72) Inventors: Barbara L. MCANENY, Albuquerque, NM (US); Jennifer WEBSTER, Albuquerque, NM (US)

(21) Appl. No.: 15/316,150

(22) PCT Filed: Jun. 17, 2015
(86) PCT No.: PCT/US2015/036139

§ 371 Date: Dec. 2, 2016

Related U.S. Application Data
(60) Provisional application No. 62/013,982, filed on Jun. 18, 2014.

(51) Int. Cl. G06F 19/00

(52) U.S. Cl. CPC G06F 19/322; G06F 19/325; G06F 19/328; G06F 19/3431

(57) ABSTRACT

Some examples of the disclosure are directed to the processing of medical claims data, electronic health records (EHR) data and other data to define disease/treatment pools and risk bands to assist in the treatment of diseases such as cancer. In some examples, in accordance with these defined disease/treatment pools and risk bands, participating practices (e.g., health care providers, clinics, cancer centers, etc.) can provide outpatient care in accordance with determined triage pathways that ensure patients receive the right care in the right place at the right time for symptoms related to their disease(s) and treatment, and determined clinical pathways that address, as applicable, appropriate imaging, pathologic testing and molecular diagnostics, delineating chemotherapy, radiation oncology, supportive care, and surgery. A centralized system may monitor electronic health records maintained by the participating practices to determine whether the participating practices are in compliance with determined clinical pathways.

### FIELD OF THE DISCLOSURE

This relates generally to the treatment of diseases, and in some examples to the processing of patient claims data, electronic health records and other data to determine disease/treatment pools, risk bands, and compliance with clinical pathways to assist in the treatment of diseases such as cancer.

### BACKGROUND OF THE DISCLOSURE

Cancer patients are often acutely ill, and may require complex and expensive treatments and suffer treatment side effects that need to be effectively managed. One model of care delivery is the concept of a patient-centered medical home (PCMH). Some of the goals of PCMHs are to achieve improved quality and higher patient satisfaction. Most medical home treatment models are based on the Chronic Care Model (CCM), for which there is plentiful research documenting the positive effects of the CCM on chronic disease outcomes. Recent studies have shown that medical homes can significantly reduce costly emergency department (ED) visits and inpatient admissions in a variety of populations. Medical home patients often report better doctor-patient interactions, coordination and timeliness of care, access to care, and helpfulness of staff. However, comprehensive analysis-based processes and systems are needed to effectively implement these medical home models and provide the best treatment possible under the circumstances. For example, medical practitioners sometimes use independent systems to administer oncology pathways and measure adherence to those pathways. With these independent systems, a practitioner manually enters patient information such as a diagnosis and a cancer stage and the system identifies a known treatment plan from the practitioner-entered information. The patient information must also be separately entered into an electronic health record (EHR) system that stores official electronic health records for each patient. The use of independent systems may be error-prone and can lead to sub-optimal patient care when a medical practice deviates from desired treatment paths.

### SUMMARY OF THE DISCLOSURE

Because treatment for diseases such as cancer can be highly complex and expensive, ensuring high quality of care, patient-centeredness and cost-effectiveness are often critical goals of a treatment system. Accordingly, some examples of the disclosure are directed to the processing of medical claims data, electronic health records (EHR) data and other data to define disease/treatment pools and risk bands to assist in the treatment of diseases such as cancer. In some examples, in accordance with these defined disease/treatment pools and risk bands, participating practices (e.g., health care providers, clinics, cancer centers, etc.) can provide outpatient care in accordance with determined triage pathways that ensure patients receive the right care in the right place at the right time for symptoms related to their disease(s) and treatment, and determined clinical pathways that address, as applicable, appropriate imaging, pathologic testing and molecular diagnostics, delineating chemotherapy, radiation oncology, supportive care, and surgery.

The medical home treatment system according to some examples of the disclosure can compute and implement these data-based and analytically-derived clinical pathways to keep patients in the physician's office for care and out of the hospital and ED as much as possible. The medical home treatment system may include central computing systems that monitor electronic health records maintained by physicians at remote computing equipment to determine whether patient care complies with the clinical pathways. The medical home treatment system can additionally offer enhanced services such as patient education and medication management counseling, team care, 24/7 practice access (telephone triage, evening/weekend clinic hours, EHR access through patient portals and on-call clinicians), on-site or near-site imaging and laboratory testing, and admitting physicians who shepherd patients through inpatient encounters, avoiding handoffs and readmissions, to ensure seamless, safe and efficient care.

### BRIEF DESCRIPTION OF THE DRAWINGS

FIG. 1 illustrates an example system that can be used to implement some examples of the disclosure.

FIG. 2 illustrates an example process for generating disease/treatment pools, risk bands, and payment amounts according to some examples of the disclosure.

FIG. 3 illustrates an example framework for disease/treatment pools and risk bands that can be defined according to some examples of the disclosure.

FIG. 4 illustrates an example block diagram of a medical home treatment system according to some examples of the disclosure.

FIG. 5 illustrates a more comprehensive block diagram of a medical home treatment system according to some examples of the disclosure.

FIG. 6 illustrates an example medical home treatment system informational architecture according to some examples of the disclosure.

FIG. 7 illustrates an example system in which centralized computing equipment may retrieve patient information from an electronic health record stored at medical provider computing equipment according to some examples of the disclosure.

FIG. 8 illustrates an example clinical pathway corresponding to a sequence of events according to some examples of the disclosure.

FIG. 9 illustrates an example of a sequence of events that form a clinical pathway according to some examples of the disclosure.

FIG. 10 illustrates a process for creating communications interfaces between central computing equipment and medical practice computing equipment according to some examples of the disclosure.

FIG. 11 illustrates a process for monitoring pathway compliance for patients of a medical practice using a communications interface between the medical practice and central computing equipment according to some examples of the disclosure.

FIG. 12 illustrates a process for identifying new patients at a medical practice based on patient information retrieved using a communications interface between the medical practice and central computing equipment according to some examples of the disclosure.

FIG. 13 illustrates an example of a user interface that displays compliance information for a selected practice in comparison to all monitored practices according to some examples of the disclosure.

FIG. 14 illustrates an example of a pathway compliance table including compliance information for clinical pathway events of several monitored patients of several physicians according to some examples of the disclosure.

FIG. 15 illustrates a process for determining whether a medical practice is in compliance with a clinical pathway for a patient according to some examples of the disclosure.

FIG. 16 illustrates a process for determining whether a medical practice is in compliance with an illustrative clinical pathway for metastatic disease according to some examples of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

Because treatment for diseases such as cancer can be highly complex and expensive, ensuring high quality of care, patient-centeredness and cost-effectiveness are often critical goals of a treatment system. Accordingly, some examples of the disclosure are directed to the processing of medical claims data, EHR data and other data to define disease/treatment pools and risk bands to assist in the treatment of diseases such as cancer. In some examples, in accordance with these defined disease/treatment pools and risk bands, participating practices (e.g., health care providers, clinics, cancer centers, etc.) can provide outpatient care in accordance with determined triage pathways that ensure patients receive the right care in the right place at the right time for symptoms related to their disease(s) and treatment, and determined clinical pathways that address, as applicable, appropriate imaging, pathologic testing and molecular diagnostics, delineating chemotherapy, radiation oncology, supportive care, and surgery.

The medical home treatment system according to some examples of the disclosure can compute and implement these data-based and analytically-derived clinical pathways to keep patients in the physician's office for care and out of the hospital and ED as much as possible. The medical home treatment system may include central computing systems that monitor electronic health records maintained by physicians at remote computing equipment to determine whether patient care complies with the clinical pathways. The medical home treatment system can additionally offer enhanced services such as patient education and medication management counseling, team care, 24/7 practice access (telephone triage, evening/weekend clinic hours, EHR access through patient portals and on-call clinicians), on-site or near-site imaging and laboratory testing, and admitting physicians who shepherd patients through inpatient encounters, avoiding handoffs and readmissions, to ensure seamless, safe and efficient care.

It should be noted that although some examples of the disclosure may be described herein with respect to oncology, it should be understood that the examples of the disclosure are not so limited, but can be applied to any type of disease, condition or injury that requires complex and expensive treatment.

Hardware System Overview.

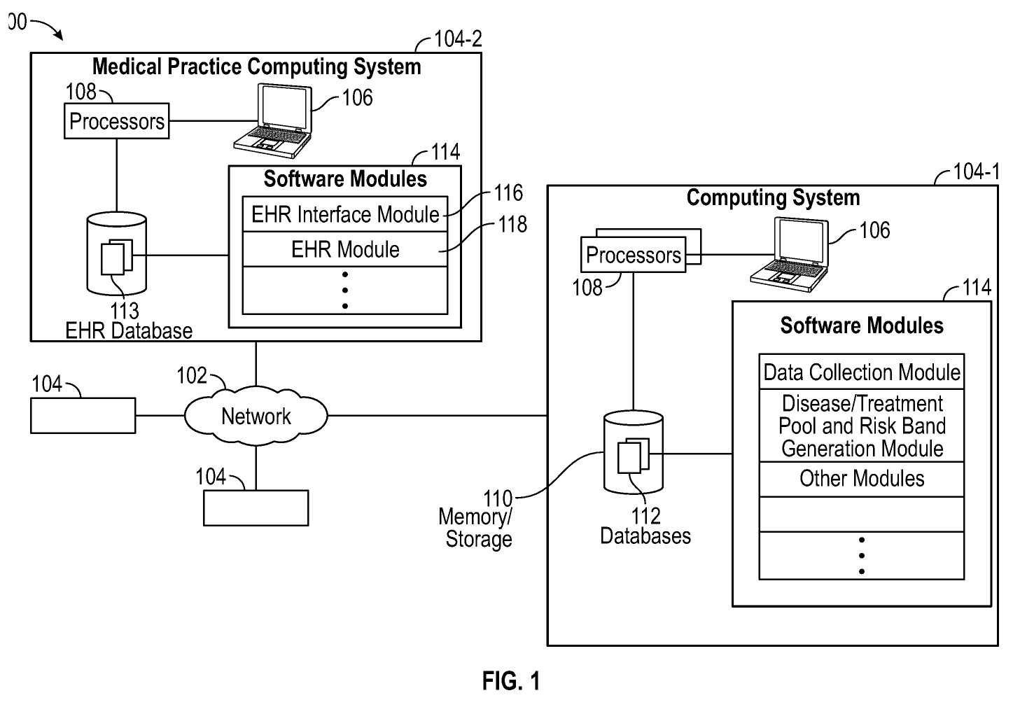

FIG. 1 illustrates an example system 100 that can be used to implement some examples of the disclosure. In the example of FIG. 1, network 102 can communicatively connect one or more remote and/or centralized computing systems 104, which may be located in separate facilities. Computing systems 104 can include, but are not limited to, computing terminals 106, one or more processors 108, and one or more memory or storage modules 110, which may contain one or more databases 112 and software modules 114 that can be executed by the one or more processors 108 to perform operations that will be described below.

In some examples, one or more computing systems 104 can be located remotely at one or more practices, while one or more other computing systems can be located at one or more centralized locations, such as at the location of an agency administering or managing a medical home treatment system according to some examples of the disclosure. As shown in FIG. 1, computing system 104-2 may serve as a medical practice computing system that is located remotely at a medical practice, whereas computing system 104-1 may serve as a central computing system that monitors and communicates with remote computing systems such as system 104-2. Central computing system 104-1 may monitor the remote computing systems in determining whether medical practices associated with the remote computing system are in compliance with treatment pathways.

Medical practice computing system 104-2 may include software modules such as EHR interface module 116, EHR module 118, and other software modules. EHR module 118 may include instructions for processors 108 to implement an electronic health record system for the corresponding medical practice. EHR module 118 may receive patient information from practitioners (e.g., via input devices at terminals 106) and store the data by modifying or creating entries in EHR database 113. In response to requests for patient information received at terminals 106, EHR module 118 may retrieve and display the requested information via output devices at terminals 106.

The example of FIG. 1 in which EHR patient information is stored in database 113 is merely illustrative. If desired, patient information may be stored in any desired data structure, including databases, tables, and/or lists.

EHR systems implemented by different medical practices can be diverse and varied. For example, the EHR system implemented by a corresponding EHR module and EHR database at a particular remote computing system 104 may be different from the EHR system implemented at another remote computing system 104. It can be challenging for central computing system 104-1 to access information from different EHR systems. For example, a first EHR system may store patient information using different labels than a second EHR system (e.g., different database values such as a different string of characters, a different integer value, etc.). Physicians or other medical practitioners at different practices may enter different terms or phrases to represent the same type of patient information. As another example, an EHR module at a first medical practice computing system may respond differently to network communications than an EHR module at a second medical practice computing system.

Optional EHR interface module 116 may help to facilitate communications between central computing system 104-1 and remote EHR systems. EHR interface module 116 may receive requests for information from the central computing system (e.g., from a data collection module) and retrieve the appropriate information from the corresponding EHR database. Information retrieved from the corresponding EHR may be communicated to the central computing system in a standardized format that may help to facilitate efficient data collection and monitoring of medical practice compliance with desired clinical pathways.

Note that one or more of the analyses, operations or processes described herein can be performed by software or firmware stored in memory or storage 110 and executed by processor(s) 108 in either the remote or centralized computing systems 104, or in a combination thereof. The firmware can also be stored and/or transported within any non-transitory computer-readable storage medium for use by or in connection with an instruction execution system, apparatus, or device, such as a computer-based system, processor-containing system, or other system that can fetch the instructions from the instruction execution system, apparatus, or device and execute the instructions. In the context of this document, a “non-transitory computer-readable storage medium” can be any medium (excluding a signal) that can contain or store the program for use by or in connection with the instruction execution system, apparatus, or device. The non-transitory computer readable medium storage can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The software/firmware can also be propagated within any transport medium for use by or in connection with an instruction execution system, apparatus, or device, such as a computer-based system, processor-containing system, or other system that can fetch the instructions from the instruction execution system, apparatus, or device and execute the instructions. In the context of this document, a “transport medium” can be any medium that can communicate, propagate or transport the program for use by or in connection with the instruction execution system, apparatus, or device. The transport readable medium can include, but is not limited to, an electronic, magnetic, optical, electromagnetic or infrared wired or wireless propagation medium.

It is to be understood that system 100 is not limited to the components and configuration of FIG. 1, but can include other or additional components in multiple configurations according to various examples.

Construction of Disease/Treatment Pools and Risk Bands.

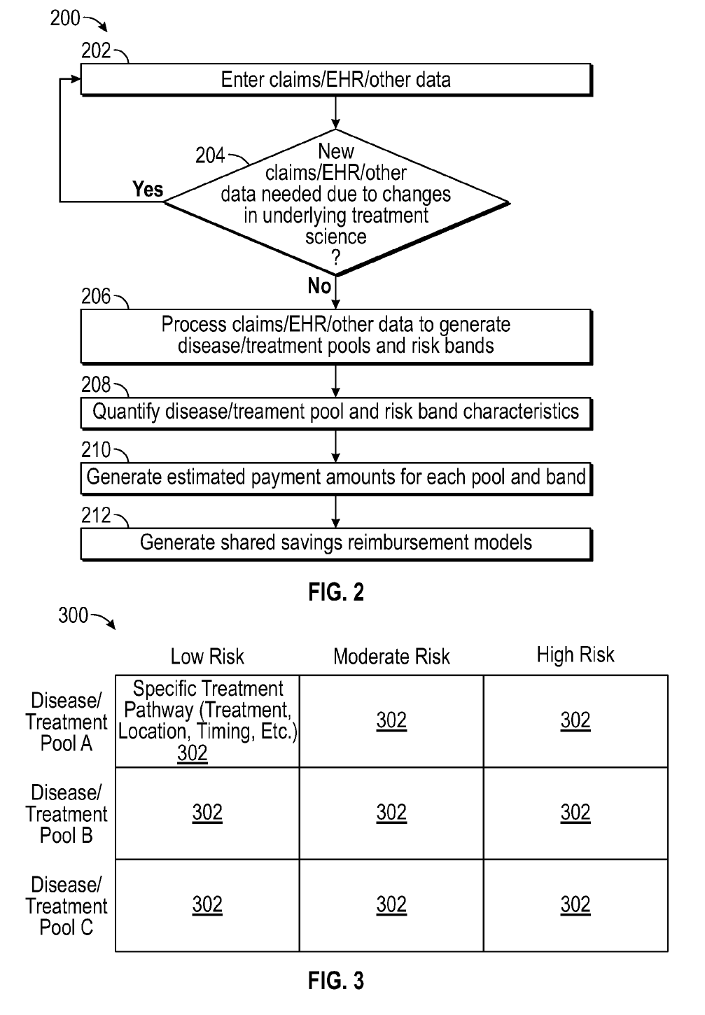

FIG. 2 illustrates an example process 200 for generating disease/treatment pools, risk bands, and payment amounts according to some examples of the disclosure. To support the construction of disease/treatment pools and risk bands, in some examples of the disclosure, claims data, EHR data and other data can be entered into the system at 202. In some examples, customized data collection software having customized clinical interfaces (dashboards) can be executed to ensure the timely, consistent and accurate collection of claims data and EHR data. In some examples, the customized data collection software can identify specific information that may be needed for the generation of disease/treatment pools and risk bands. In some examples, the software may allow for open-ended input, but in other examples, menus of possible inputs may be employed to ensure that the collected claims data is of a consistent type and format.

In some examples, claims data, EHR data and other data can be entered and stored in memory or storage at a computing system located remotely at a particular practice site, and that data can be transmitted over the network to a computing system at a central location for further processing. In other examples, computing systems at a central location may be directly accessed over the network using remote computing systems to enter claims data, EHR data and other data directly into the central location. In some examples, the customized data collection software can run in a central location, and by initiating communications over the network, can automatically pull EHR data and other data from databases stored at a practice site, or claims data from databases stored at a payer (e.g., health insurance provider) site.

In some examples, new claims data, EHR data or other may be needed at 204 due to changes in the underlying treatment science (e.g. new genetic testing, new chemotherapy regimens), and as a result, new claims data and EHR data reflective of the new science can be gathered at 202.

In some examples, the claims data, EHR data and other data can be processed using customized disease/treatment pool and risk band software at 206 to generate disease/treatment pools and risk bands, or adjust existing disease/treatment pools and risk bands. In some examples, the customized disease/treatment pool and risk band software can also generate and implement rules for automating the assignment of patients to disease/treatment pools and risk bands. In some examples, the customized disease/treatment pool and risk band software can be executed at a computing system in a central location, but in other examples, the software can be executed in any computing system in the overall system. In other examples, the customized disease/treatment pool and risk band software can generate and implement rules for when patients should be reassigned to a new pool or band (based on disease progression or change in treatment).

FIG. 3 illustrates an example framework for disease/treatment pools and risk bands 300 that can be defined according to some examples of the disclosure. In the example of FIG. 3, three disease/treatment pools A, B and C are shown, and three risk bands (low, moderate and high) are shown, although it should be understood that any number of disease/treatment pools and risk bands can be employed. For each disease/treatment pool and risk band intersection, one or more particular treatment pathways 302 can be developed based on the received claims data, EHR data and other data for that particular disease and level of risk. The treatment pathway 302 can include, but is not limited to, a sequence of treatments and/or tests administered in particular locations at particular times. The treatments and/or tests of each sequence may sometimes be referred to as events that are required to be completed in a particular order for compliance with the pathway. For example, based upon compiled historical data that may include diagnoses, treatments, locations, timing and outcomes extracted from the claims data, EHR data and other data, a sequence of treatments and/or tests for a particular disease or condition, administered in particular locations at particular times, can be defined for a particular disease/treatment pool and risk band.

Returning again to FIG. 2, using standardized reporting formats and available claims data, the cost homogeneity and drivers for each disease/treatment pool, the potential stability of each pool, and alternative pool definitions can also be generated by the customized disease/treatment pool and risk band software at 208. In addition to generating disease/treatment pools and risk bands, the claims data can also be used by the customized disease/treatment pool and risk band software to generate estimated payment amounts for each pool and band at 210. This information can be stored, for example, in storage or memory in a centralized location.

After the estimated payment amounts and other characteristics for each disease/treatment pool and risk band have been generated at 208 and 210, shared savings reimbursement models can be generated at 212. The shared savings reimbursement model 212 can include, but is not limited to, the prospective credit amounts for a patient newly assigned to a disease/treatment pool and risk band, and also how and when payers will make payments to the providers. In addition, the shared savings model can provide for how the shared savings reimbursement model will be updated, and how to make payments when a patient that, for clinical reasons or due to patient preferences, needs to transition between patient pools.

The Bundled Payments/Shared Savings Model.

The generation of disease/treatment pools and risk bands as described above can enable providers to provide high-quality, cost-effective patient-centered care by specifying the type, timing, and location of best practice treatments with a proven history of success based on the gathered claims, EHR data and other data. In some examples of the disclosure, further enhancements to quality and efficiency can be achieved by incentivizing clinicians to provide evidence-based care and reduce practice variation. In some examples, the medical home treatment system according to some examples of the disclosure can use payer savings to cover provider costs and further incentivize best practices while maintaining high quality care. Specifically, some examples of the disclosure implement bundled payments coupled with quality monitoring and incentives payments as well as shared savings/risk for cost overruns. Bundled payments tailored to clinical conditions can incentivize practices to eliminate unnecessary care variation, reducing costs and improving quality of care.

The medical home treatment system according to some examples of the disclosure emphasizes outpatient care whenever practical, replacing costly inpatient and ED care with cost-effective and safe outpatient care. This model of care requires commitment and investment on the part of providers that will be rewarded through quality incentive payments and shared savings. Two other key features of some examples of the medical home treatment system are robust provider participation in the development and refinement of the payment model and transparency of payment and cost/utilization information. These features can be critical to ensure ongoing provider participation in payment reform.

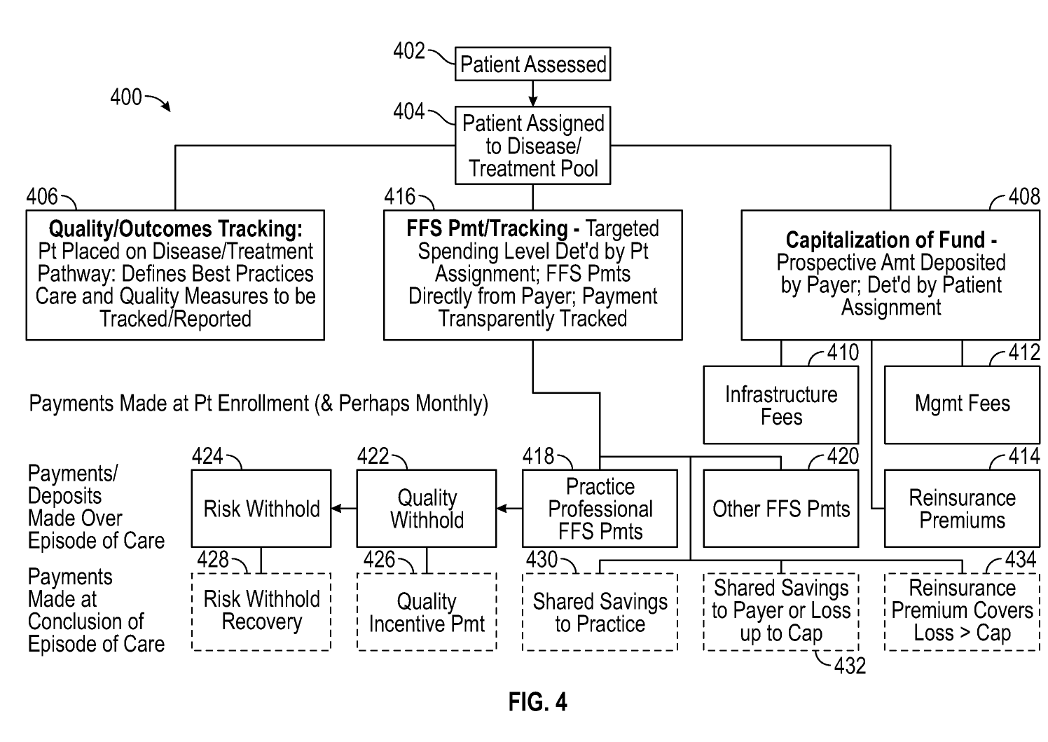

FIG. 4 illustrates an example block diagram 400 of the medical home treatment system according to some examples of the disclosure.

Enrollment.

In some examples of the disclosure, Medicare, Medicaid and commercially insured patients with diseases such as breast, lung and colorectal cancer undergoing active treatment at a participating practice can be automatically enrolled in the medical home treatment system after the patients have been assessed and are ready to begin a new phase of treatment (see block 402 in FIG. 4). In some examples, these phases can correspond to the beginning of a new disease/treatment pool, risk band and corresponding payment bundle for that new pool and band, and may include new diagnoses, disease progression, or transition to maintenance therapy. Enrollment can occur at a remote computing system in the office of a provider, and can be communicated to a central computing system of the system administrator, for example.

This automatic enrollment approach can be useful to ensure adequate risk pooling and patient tracking, and can make the task of population tracking simpler than a separate enrollment process (in addition to standard patient registration) in situations when a practice has agreed that all patients undergoing active treatment will be included in the medical home treatment system. However, in other examples, in order to provide relatively straightforward, more predictable, and conservative cost savings projections, the medical home treatment system according to some examples of the disclosure may be made available only to patients with newly diagnosed and newly elapsed diseases such as breast, lung, and colon cancer, or in general to any patients for which treatment of their diseases or conditions can result in the most significant cost savings.

Assignment of Disease/Risk Band.

Based on clinical characteristics, best practice treatment approaches and optionally patient preferences, a patient can be assigned to a disease/treatment pool and risk band at block 404. In some examples, as discussed above, the assignment of a patient to a particular disease/treatment pool and risk band can be performed in an automated fashion by software running in a computing system. In those examples where patient assignment is performed in an automated manner, patient assessment information can be entered at a local computing system or a central computing system, and the customized disease/treatment pool and risk band software described above can utilize rules generated during the formation of the disease/treatment pools and risk bands to automate the assignment. This assignment places a patient on a treatment pathway at block 406 with well-defined, disease-specific quality and outcome measures that can be monitored throughout the patient's treatment episode of care to ensure they are receiving the right care, at the right time and at the right place.

Allocate Bundled Payment According to Disease/Risk Band and Place in Virtual Account.

At the time of patient enrollment, a prospective amount (a bundled payment), based on patient disease/treatment pool and risk band assignment, can be placed into a fund by the payer to be held in trust by the system administrator at block 408. This amount represents expected patient costs based on the patient disease/treatment pool and risk band assignment, and can be updated if the patient is reassigned to a new disease/treatment pool and risk band. In some examples, the payment amounts can be adjusted to reflect significant changes in input prices (e.g. medications/services). This fund can initially be used to pay practice “medical home” infrastructure fees, management fees and reinsurance premiums at 410, 412 and 414, respectively.

Make FFS Payments to Providers after Subtracting Efficiency and Quality Withholds.

Providers treating patients under the medical home treatment system according to some examples of the disclosure can bill payers on a fee for service (FFS) basis at 416. In some examples, these fees and other costs (reinsurance premiums, medical home infrastructure and management fees) can be transparently tracked using internal financial data and claims data in order to calculate risk sharing payments and keep providers and payers aware of performance.

During the course of the patient episode of care, upon receiving invoices from the practices, the fund 408 can pay both practice 418 and non-practice 420 FFS payments, but one or more withholds on the payments can be used to incentivize provider performance: a percentage withhold on provider professional billings for a “quality pool” (e.g., 2%) at block 422 to incentivize quality, and a similar amount for an “efficiency pool” at block 424 to incentivize efficiency. In some examples, the level of risk to be assigned to providers can be sufficiently large to ensure that the providers have “skin in the game,” but not so large as to endanger the financial viability of the practice.

Evaluation of Pathway Compliance.

Through the medical home treatment system according to some examples of the disclosure, cost savings can be realized because ED visits and inpatient encounters are expected to be reduced as patient care is more effectively delivered in the physician office, precluding the need for ED and inpatient services. The bundled payments/shared savings model according to some examples of the disclosure can also reduce ED visits and inpatient utilization through financial incentives to increase efficiency. The bundled payments/shared savings model according to some examples of the disclosure can also reduce variations in costs care by incentivizing providers to remain on pathways (through the quality pool), which can result in reduced imaging and testing (those that are not required for the pathway or duplicative) and, potentially, modest reductions in medication spending.

In some examples of the disclosure, pathway compliance and quality measurement (achievement of quality benchmarks) can be used to determine “quality incentive payments” (e.g., up to 2% of professional practice FFS payments), and “efficiency incentive payments” (e.g., up to 2% of professional practice FFS payments). To facilitate ongoing monitoring, a set of quality, outcomes and financial measures can be generated that can be tracked and reported on a periodic (e.g., quarterly) basis. Evaluation measures can include, but are not limited to, (1) the number of patients by clinic and patient type, collected on a periodic basis (e.g., monthly), (2) provider satisfaction from electronic questionnaires sent at predetermined intervals (e.g., every six months), (3) patient satisfaction from electronic questionnaires sent at predetermined intervals (e.g., every six months), (4) Quality Oncology Practice Initiative (QOPI) measures collected on a periodic basis (e.g., monthly), (5) inpatient admissions per patient by patient type, collected on a periodic basis (e.g., monthly), (6) ED admissions per patient by patient type, collected on a periodic basis (e.g., monthly), and (7) total episode expenditures and average savings (or loss) by patient type, collected on a periodic basis (e.g., monthly).

In some examples of the disclosure, gains and losses can be determined by comparing the prospective determined amount put into the fund against all FFS payments, reinsurance premiums and other medical home costs (infrastructure and management fees). At the conclusion of the patient episode of care, a final accounting can determine whether practices recover their quality incentive withhold at block 426, and their risk incentive withhold at block 428, whether there are savings to be shared between the practice and the payer, and whether losses (payer) or excess losses (reinsurer) will need to be recovered.

Distribution of Shared Savings.

In some examples of the disclosure, savings after reinsurance, medical home, and management fees can be shared between the practice at block 430 and payer at block 432, at a negotiated rate. To avoid over-incentivizing gains, in some examples shared savings may be capped. In some examples, gains in excess of a predetermined cap can be diverted to a general administrative fund to cover future expenses and/or returned to the payer. If gains consistently exceed this cap or if practices are consistently unable to deliver care for less than the bundled amount, model assumptions can be revisited and payments adjusted accordingly.

Sharing in Cost Overruns.

In some examples of the disclosure, for those practices that do not meet quality and/or efficiency targets, some or all of withholds may be forfeited and deposited to the general fund. Cost overruns may be shared equally by provider (via loss of the risk withhold) and payer up to a cap at block 432. Excess losses above the negotiated level may be covered through reinsurance at block 434.

Functional System Architecture.

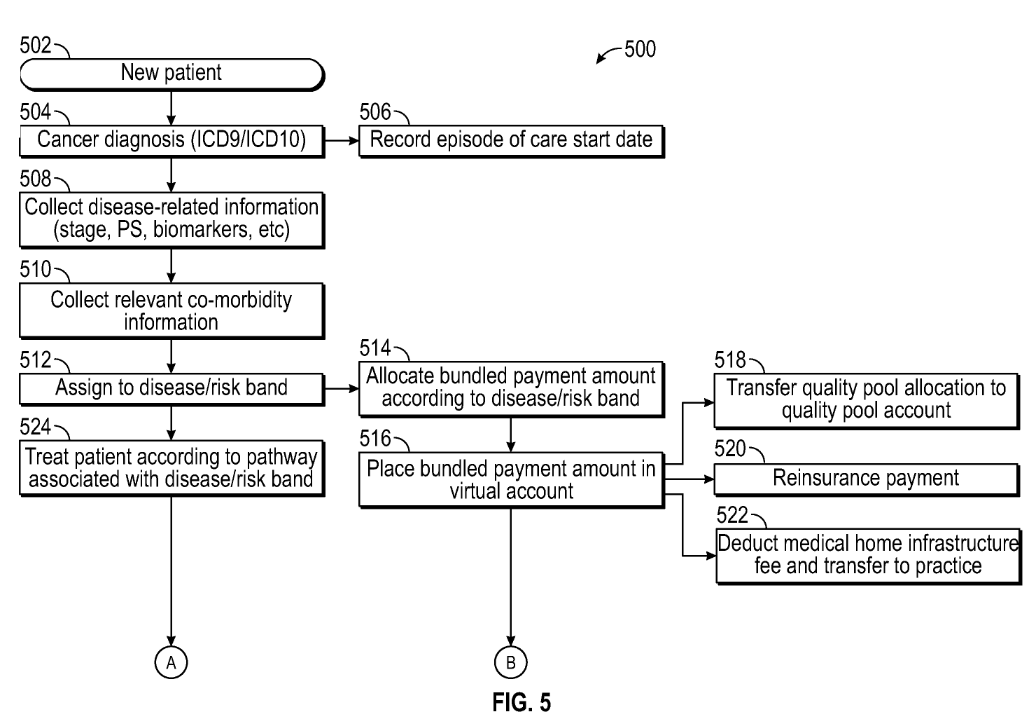

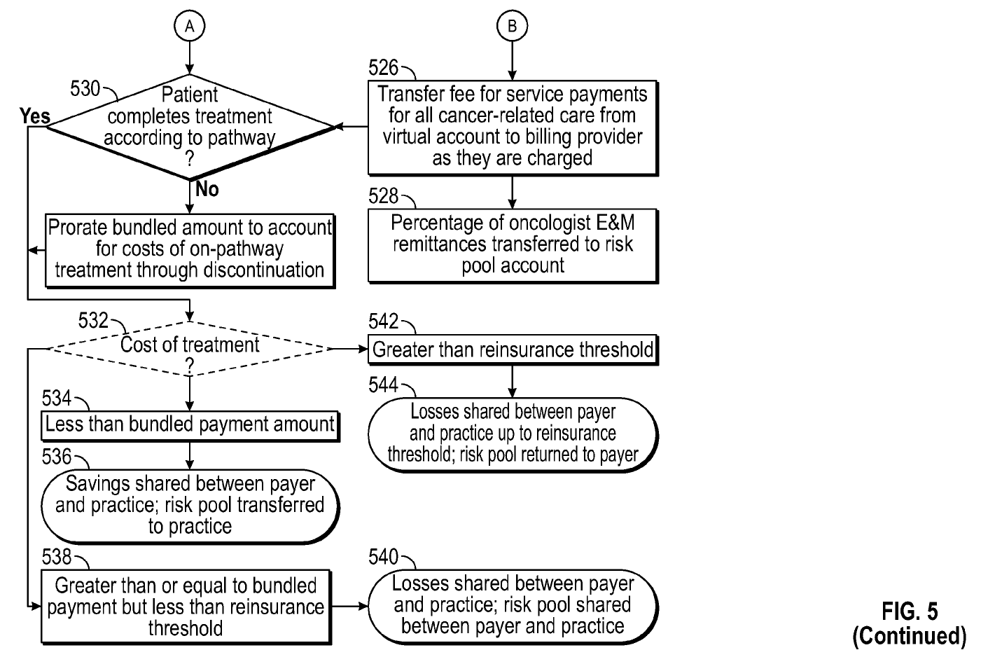

FIG. 5 illustrates a more comprehensive block diagram 500 of a medical home treatment system according to some examples of the disclosure. In the example of FIG. 5, a new patient is presented at block 502. A diagnosis (e.g., cancer) can be made at block 504, and the episode of care start date can be recorded at 506. Disease-related information can be collected at block 508. Relevant co-morbidity information can be collected at block 510. At block 512, the patient can be assigned to a disease/treatment pool and optionally a risk band.

At that time, a bundled payment amount can be allocated according to the disease/treatment pool and risk band at block 514, and the bundled payment amount can be placed in a virtual account at block 516. Some of the bundled payment amount can be designated as a quality pool allocation and transferred to a quality pool account at block 518. Some of the bundled payment amount can be designated for reinsurance payments at block 520. Some of the bundled payment amount can be designated as medical home treatment system infrastructure fees and transferred to providers at block 522.

The patient can be treated according to the pathways specified in the assigned disease/treatment pool and risk band at block 524. As services are provided to the patient by provider, the provider can bill the system administrator, and the FFS payments can be transferred from the virtual account to the provider at block 526, less a percentage that can be transferred to a risk pool account at block 528.

If the patient is treated in accordance with the pathway at block 530, and if the cost of the treatment is determined at block 532 to be less than the bundled payment amount at block 534, then the savings can be shared between the payer and provider, and the risk pool amount can be transferred to the provider at block 536. On the other hand, if the cost of treatment is greater than or equal to the bundled payment amount but less than a reinsurance threshold at block 538, then the losses can be shared between the payer and the provider, as the risk pool amount can be shared between the payer and the provider at block 540. If the cost of treatment is greater than the reinsurance threshold at block 542, then the losses can be shared between the payer and provider up to the reinsurance threshold and the risk pool amount is returned to the payer at block 544.

If the patient is not treated in accordance with the pathway, then the bundled amount can be prorated to account for costs of on-pathway treatment through discontinuation at block 546.

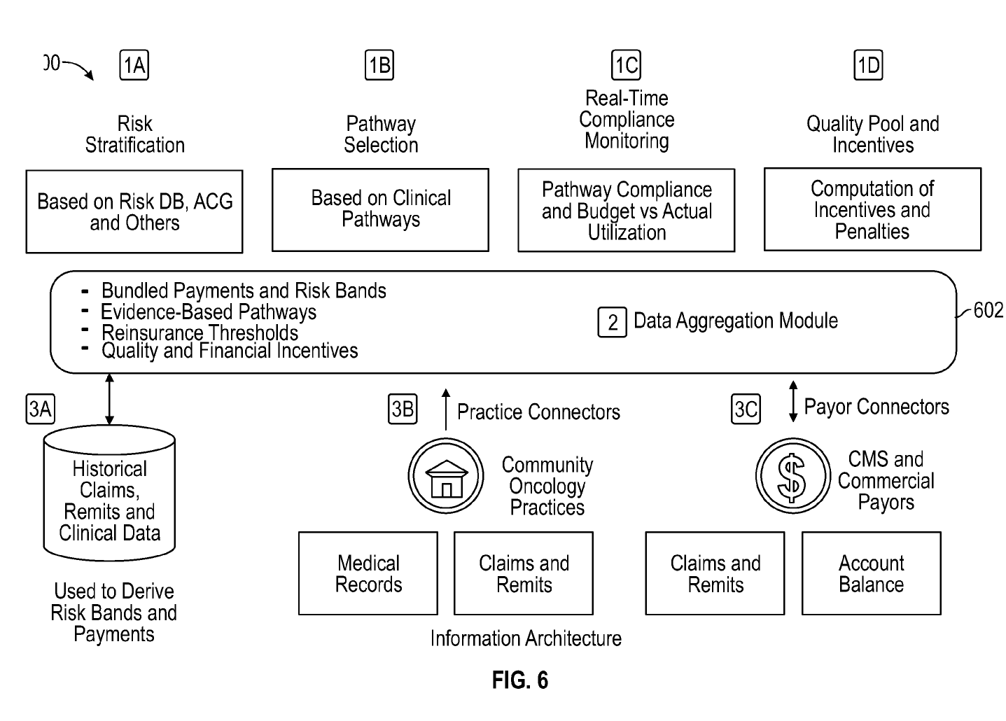

FIG. 6 illustrates an exemplary medical home treatment system informational architecture 600 according to some examples of the disclosure. In the example of FIG. 6, data aggregation module 602 can serve as the foundation of the informational architecture. The data aggregation module 602 can include, but is not limited to, evidence-based disease/treatment pools and corresponding pathways, risk bands, bundled payments that correspond to disease/treatment pools and risk bands, reinsurance thresholds, and quality and financial incentives. As an example, data aggregation module 602 may be a clinical and financial operating system (cOS) or other data aggregation software. If desired, module 602 may be enterprise software configured to process information related to a medical home system (e.g., electronic health record data or claims data) to handle tasks such as pathway compliance monitoring, risk stratification, pathway selection and/or incentives computation. Risk stratification 1A, or the creation of risk bands, can be based on claims and EHR data. Pathway selection 1B can be determined after a patient has been assigned to a disease/treatment pool and risk band. Real-time compliance monitoring 1C can involve utilizing claims and EHR data to determine compliance with the identified pathway, and a comparison of the budget amount versus actual utilization. Quality pool and incentives 1D can include the initial determination of risk and quality withholds, as well as the computation of incentives and penalties.

The data aggregation module can receive historical claims, remits and clinical data at block 3A, which can be used to derive risk bands and payments at 1A and 1D. Providers such as Community Oncology Practices 3B can submit EHR data, claims and remits to the data aggregation module via remote computing systems. Payers 3C can maintain accounts, receive claims and remits, and pay providers through the data aggregation module.

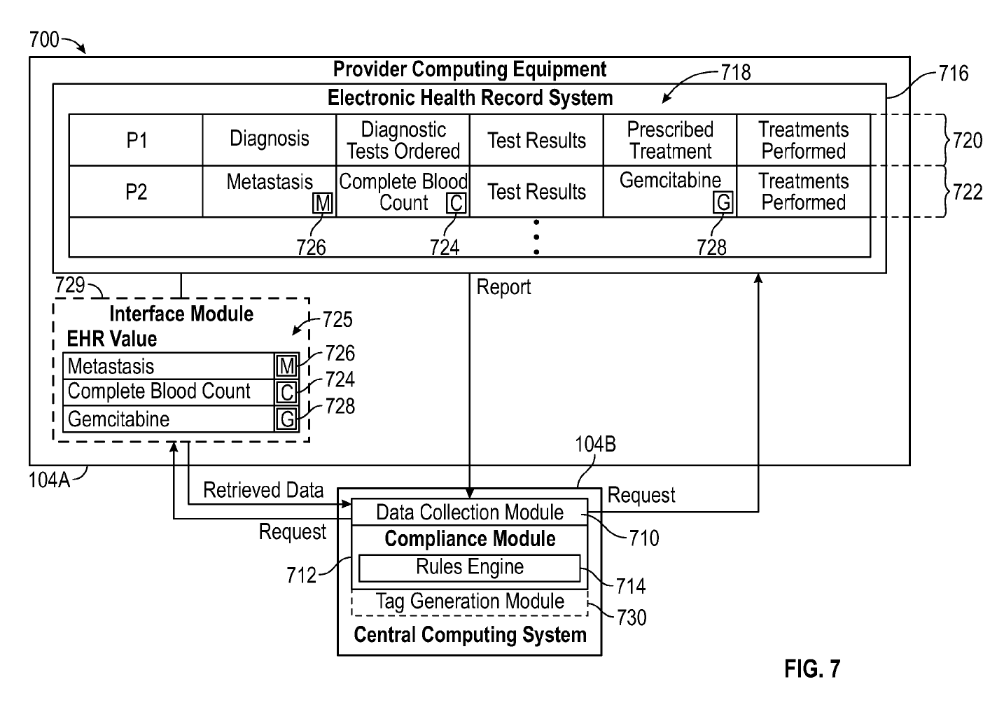

FIG. 7 illustrates an exemplary medical home treatment system in which a central computing system 104B may monitor provider computing equipment 104A in determining whether patient care is in compliance with desired clinical pathways. Computing systems 104B and 104A may include hardware and software similar to computing systems 104 of FIG. 1 (e.g., processors 108, terminal 106, memory/storage 110, and software modules 114), though some features have been omitted for clarity.

Central computing system 104B may include data collection module 710 and compliance module 712. Software modules 710 and 712 may be implemented as instructions stored in memory/storage that configure one or more processors to perform specific tasks (e.g., as described in connection with FIG. 1). Provider computing equipment 104A may include electronic health record system 716 that maintains an electronic health record 718. For example, electronic health record system 716 may be implemented similarly to FIG. 1 (e.g., including EHR module 116 that configures processors 108 to maintain an electronic health record stored in EHR database 113 as shown in FIG. 1). Electronic health record 718 may include entries such as entries 720 and 722 that store patient information. The patient information may identify a particular patient, information regarding that patient's visit to a medical practice, diagnostic tests that have been ordered, test results, prescribed treatment, treatments performed, and other information relating to a patient. Entry 720 may include information identifying a patient P1 such as a medical record number (MRN), the patient's age, prescription medicines for the patient, and other patient information relating to the patient such as a diagnosis, diagnostic tests ordered, etc. These examples are merely illustrative. Electronic health record entry 720 may include any number of fields that store desired information relating to the patient, such as cancer staging, biomarkers, communications such as counseling that have occurred between a medical practitioner and the patient, and information indicating when actions were taken or results were produced. The patient information may be entered in each field with broad or detailed specificity by a medical practitioner using electronic health record system 716.

Values entered into the fields of an electronic health record system may differ between various medical providers, which can pose challenges for central computing system 104B in retrieving desired information. For example, medical practitioners may describe a particular diagnosis using different words or identifiers. In order to help facilitate communications between electronic health record system 716 and data collection module 710, fields of entries in electronic health record 718 may be tagged with or assigned to metadata that identifies the fields and/or the values stored in the fields.

Entry 722 is an illustrative example showing how fields may be tagged with metadata. Entry 722 identifies a patient P2 (e.g., by MRN), that the patient has been diagnosed with metastasis (e.g., spreading of a cancer from one organ to another), that a complete blood count test has been ordered for the patient, and that chemotherapy using the drug gemcitabine has been prescribed as a treatment. Corresponding metadata tags may be added to electronic health record 718 that uniquely identify the fields of interest to the data collection module. The metastasis field may be tagged with metadata tag 726 that has been assigned to and identifies metastasis diagnoses. Similarly, electronic health record 718 may be modified to tag the complete blood count field and the gemcitabine field with metadata tags 724 and 728, respectively.

Central computing system 104B may include data collection module 710 and compliance module 712 that monitor patient records at provider computing equipment 104A to determine whether the corresponding medical practice is in compliance with clinical pathways. Data collection module 710 may retrieve information from electronic health record system 718 by sending requests over a network connection. As examples, data collection module 710 may request a report of all database entries, a subset of database entries conforming to filter criteria in the request, or only recently updated fields or entries (e.g., entries that were modified within a selected window of time prior to the request).

In response to a request, electronic health record system 716 may retrieve the requested entries and/or fields from electronic health record 718, and generate a report from the retrieved information. For example, the electronic health record system 716 may be configured to generate a standardized report such as a Continuity of Care Record (CCR). The report may be generated in any desired format such as using the Extensible Markup Language (XML). The generated report may include the metadata tags (e.g., because they have been assigned to particular fields and can be exported along with the practitioner-entered information). The generated report may be sent to data collection module 710 over a network path.

Data collection module 710 may receive the generated report and convey received patient information to compliance module 712. If desired, data collection module 710 may process the generated report to identify desired portions based on the metadata tags in the report. For example, data collection module 710 may filter out or otherwise exclude entries and/or fields in the report that do not have associated tags.

In some scenarios, metadata tags may be omitted from electronic health record 718 and a mapping may be provided in optional interface module 729. Optional interface module 729 may include a table 725 that maps electronic health record (EHR) values to corresponding tags. In the example of FIG. 7, a first entry may map a metastasis diagnosis (e.g., the value entered by the corresponding medical practice in a diagnosis field to represent metastasis) to corresponding metadata tag 726, whereas a second entry maps the practice-specific value for a complete blood count diagnostic test to corresponding metadata tag 724 and a third entry maps the practice-specific value for prescribing gemcitabine-based chemotherapy to metadata tag 728. Optional interface module 729 may use table 725 in identifying and retrieving entries and/or fields from electronic health record 718. For example, interface module 729 may retrieve only entries and/or fields of electronic health record 718 that match practice-specific values from table 725. In these examples, data collection module 710 may retrieve patient information from electronic health record 718 by communicating with interface module 729.

If desired, metadata tags such as tags 724, 726, and 728 may be generated automatically by central computing system 104B. Optional tag generation module 730 may be provided and configured to process the entries and fields of electronic health record 718 for each medical provider to generate and assign tags to provider-specific field values. For example, optional tag generation module 730 may be configured to process and parse natural language to assign appropriate tags based on the meaning of words that have been entered into fields of electronic health record 718 (e.g., character strings). In other examples, EHR vendors may add metadata tags to their EHRs and provide updated EHRs to the providers/practices.

The example of FIG. 7 in which data collection module 710 communicates with remote electronic health record systems and compliance module 712 processes information retrieved by data collection module 710 is merely illustrative. If desired, data collections, compliance, and/or optional tag generation functions may be performed by a single software module.

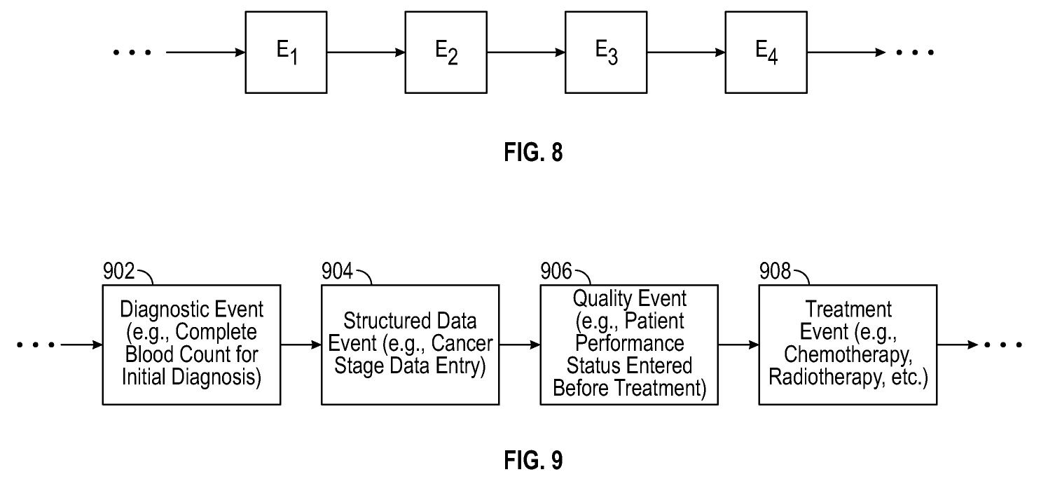

Compliance module 712 may process patient information retrieved from electronic health record system 716 to determine whether each patient's diagnosis and treatment has followed a desired sequence of events. Compliance module 712 may, for example, include a rules engine 714 that processes the retrieved event information to identify events and determine whether the identified events conform with a desired clinical pathway. FIG. 8 illustrates an example pathway including events E₁, E₂, E₃, and E₄. The events may represent actions that should have been taken by a medical practice in treating a particular patient, and may include tens or hundreds of events (as examples).

FIG. 9 illustrates an exemplary sequence of various types of events that may be included in a clinical pathway for a particular patient. Diagnostic events such as event 902 may include imaging, lab work, pathology, genetic counseling, staging, and other steps or events that are associated with the initial diagnosis of the patient. Structured data events such as event 904 may include events such as whether or not desired patient data has been entered for the patient into fields of an electronic health record. Structured data events may include whether or not the electronic health record has been updated with a patient's cancer stage, performance status, diagnosis code, relevant biomarkers, or other patient-related data. Quality events such as event 906 may serve to help monitor whether the diagnosis and treatment of a patient has been timely and/or in a desired order. For example, quality event 906 may require that a patient's performance status be entered into the electronic health record prior to any treatment events. As another example, quality event 906 may require that staging be performed within one month of a patient's first visit. Quality events 906 may be selected from sets of validated measures such as those defined by the Quality Oncology Practice Initiative (QOPI), the National Quality Forum (NQF), the National Committee for Quality Assurance (NCQA), and the Center for Medicare/Medicaid Services (CMS). Treatment events such as event 908 may include steps or actions taken by a medical practitioner in implementing a prescribed treatment for a patient (e.g., actions relating to administering chemotherapy or radiotherapy).

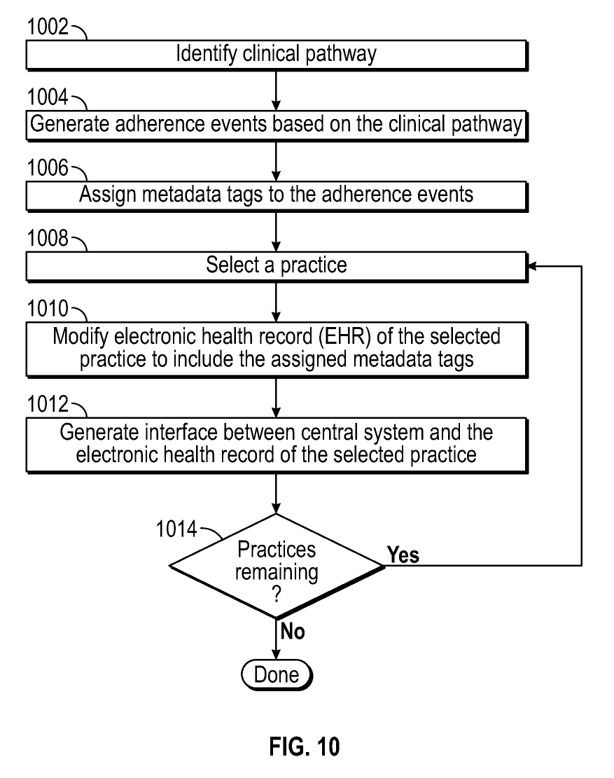

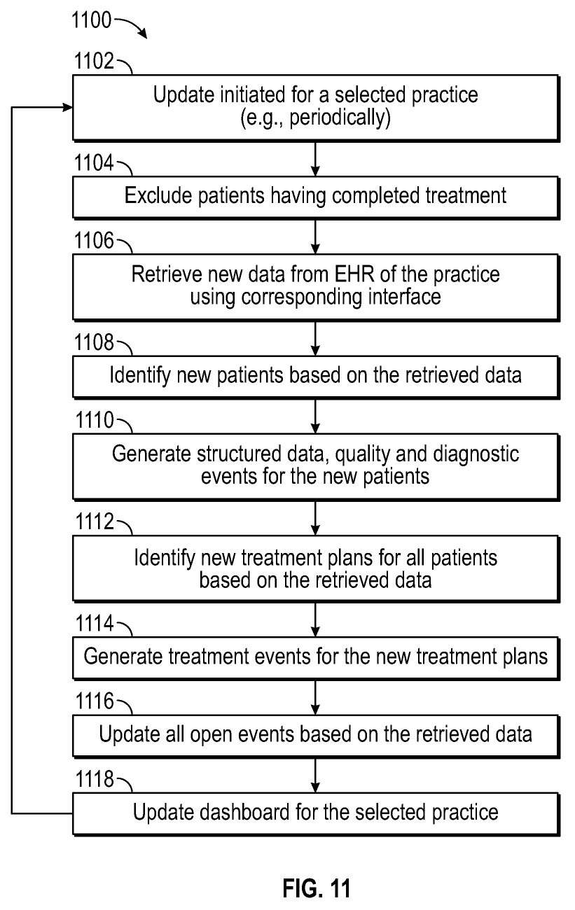

FIG. 10 illustrates an example flowchart of steps that may be performed in initializing a clinical pathway adherence system such as system 700 of FIG. 7 for a particular clinical pathway. The steps of FIG. 10 may, for example, be performed using central computing system 104B of FIG. 7.

During step 1002, the particular clinical pathway may be identified (e.g., a clinical pathway for a type of cancer). During step 1004, adherence events may be generated for the identified clinical pathway. For example, diagnostic events, structured data events, quality events, and treatment events of FIG. 9 may be generated and ordered in a sequence that represents the identified clinical pathway. During step 1006, metadata tags may be assigned to the adherence events (e.g., metadata tags 724, 726, and 728 of FIG. 7 may be assigned to fields of electronic health record 718 by a tag generation module such as module 730 or manually by a medical practitioner). During step 1008, a medical practice may be selected (e.g., by identifying a remote computing system that is maintained by the selected medical practice). During step 1010, the electronic health record of the selected practice may be modified to include the metadata tags that have been assigned to the clinical pathway. During step 1012, an interface between the central system and the electronic health record of the selected practice may be generated. For example, data collection module 710 may be configured to communicate with the remote computing system to interface with the electronic health record at the remote computing system. As another example, an interface module 729 may be implemented at the remote computing equipment (in this scenario, step 1010 may be omitted as interface module 729 performs assignment of metadata tags to electronic health record fields). At step 1014, if any participating medical practices remain to be initialized, the process may return to step 1008. If interfaces have been established and electronic health records have been modified with metadata tags for all medical practices, the process may be complete.

A central computing system may periodically monitor the electronic health record of each remote medical practice to identify new patients and determine whether diagnosis and/or treatment for existing patients are in compliance with prescribed clinical pathways. FIG. 11 illustrates an example flowchart 1100 of steps that may be taken by a compliance module of a central computing system in monitoring the electronic health record of a selected remote medical practice. As an example, the steps of flowchart 1100 may be performed using compliance module 712 and data collection module 710 of central computing system 104B of FIG. 7 in monitoring electronic health record 718. The steps of flowchart 1100 may be repeated for each remote medical practice.

During step 1102, the compliance module may initiate an update for a selected practice. Updates may be initiated periodically (e.g., daily, weekly, monthly, or at any periodic time intervals). If desired, updates may be initiated in response to stimulus such as user input at central computing system 104B.

During step 1104, the compliance module may exclude patients that have already completed their prescribed treatments. For example, the compliance module may maintain a database or other record containing information on all monitored patients, clinical pathway events that have occurred in connection with the monitored patients, whether the clinical pathway events are in compliance with prescribed treatment pathways, whether the patients have completed treatment, and other information relating to the monitored patients. The compliance module may exclude patients based on the information stored in the database.

During step 1106, the compliance module may retrieve new data from the electronic health record of the selected medical practice. In some examples, only data fields and/or entries that have been modified in the time between a previous update process and the current update process may be retrieved. The electronic health record data may be retrieved using a data collection module that has been configured as an interface with remote computing equipment that maintains the electronic health record of the selected medical practice. The data collection module may communicate with an electronic health record system at the remote computing equipment. If desired, the data collection module may communicate with the electronic health record system through an optional interface module at the remote computing equipment (e.g., optional interface module 729 of FIG. 7).

During step 1108, the compliance module may process the retrieved data to determine whether new patients have been added to the electronic health record. The compliance module may compare the retrieved data to a database of existing patients that are already being monitored. As an example, the compliance module may use metadata tags in the retrieved data to identify new patients. If desired, the compliance module may use the metadata tags to identify only new patients matching a particular initial diagnosis (e.g., only cancer patients).

The compliance module may generate clinical pathways for the new patients that may be used in determining medical practice compliance. During step 1110, the compliance module may generate structured data, quality, and diagnostic events for the new patients. The structured data, quality, and diagnostic events may be predetermined events that should be performed on all new patients or all new patients that match a particular initial diagnosis.

During step 1112, the compliance module may identify treatment plans for all new patients based on the retrieved data. The compliance module may identify the patient's initial diagnosis and prescribed treatment based on metadata tags in the retrieved data. As an example, the compliance module may use the metadata tags to identify that a type of chemotherapy or radiotherapy has been prescribed for a given patient.

During subsequent step 1114, the compliance module may identify a sequence of one or more target treatment events that should be performed by the medical practice in compliance with the identified treatment plan.

In some scenarios, clinical pathway events may define time windows during which a medical practice may perform actions or update the electronic health record in compliance with the clinical pathway events. The time windows may have a predetermined length (e.g., cancer staging should be performed and entered within one month of a patient's first visit), or may have a variable length (e.g., patient performance status should be entered into the electronic health record prior to any treatment events). Events may be closed due to data entry into associated fields of the electronic health record or due to expiration of corresponding time windows (e.g., if patient information for the appropriate electronic health record field has not been entered within the appropriate time window). The compliance module may determine that events for which the corresponding time windows have not expired and for which incomplete or no patient data has been entered are open events that still require monitoring.

During step 1116, the compliance module may process the retrieved data from the electronic health record to update open events for all monitored patients. For example, the compliance module may process metadata tags in updating the open events based on the practitioner-entered values in corresponding fields in the retrieved data. For each monitored patient, the compliance module may determine whether the practitioner-entered values match or are otherwise in compliance with the clinical pathway that has been generated for that patient (e.g., whether the medical practice has performed diagnosis, data entry, and treatment according to the sequence of target events generated for that patient during steps 1110 and 1114).

The compliance module may organize compliance data and patient data in a user interface that may be displayed to medical practitioners. As an example, the user interface may be accessed by a medical practitioner using a remote terminal. During step 1118, the compliance user interface for the selected practice may be updated with the updated event information. The compliance user interface may include compliance information specific to the selected practice and, if desired, general compliance information that may be used for comparing the performance of the selected practice to other practices.

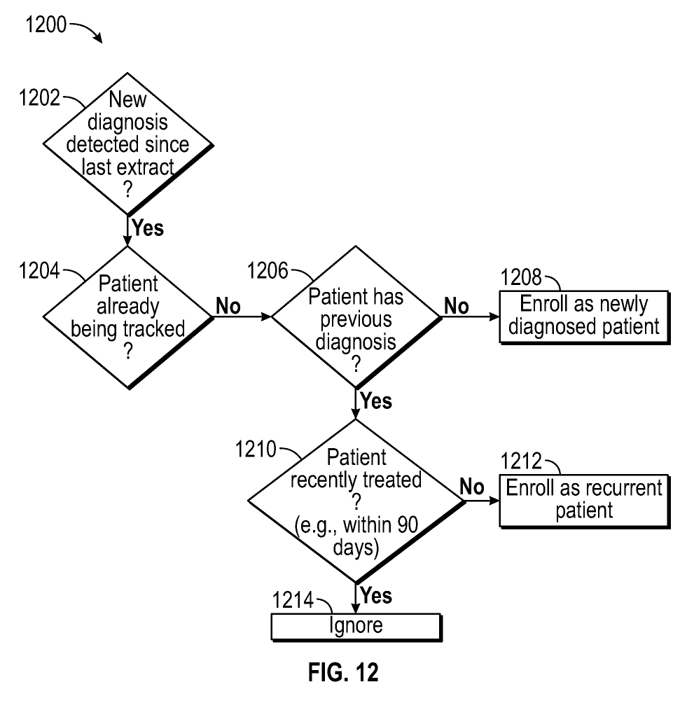

FIG. 12 illustrates an example flowchart 1200 of steps that may be performed by a compliance module in identifying new patients based on data retrieved from an electronic health record. For example, the steps of flowchart 1200 may be performed during step 1108 of FIG. 11.

During step 1202, the compliance module may detect whether a new diagnosis has occurred since a previous extract from the electronic health record. The new diagnosis may be associated with some of the patient information in the retrieved data. In response to detecting a new diagnosis, the compliance module may identify whether the patient is already being tracked during step 1204 (e.g., by comparing the associated patient information with information on patients that are already being monitored). If the patient is not already being tracked, the compliance module may determine whether the patient has been previously diagnosed with the same disease (e.g., the same cancer) during step 1206. If the patient has not been previously diagnosed with the same disease, the compliance module may enroll the patient as a new patient during step 1208. The patient may be enrolled, for example, by adding the patient to a database of currently monitored patients. By performing steps 1204, 1206, and 1208, the compliance module considers patients to be eligible for monitoring for a given disease despite having been previously monitored for a different disease.

If the patient has previously had the same diagnosis, the compliance module may determine whether the patient has been recently treated at step 1210. For example, the compliance module may process the electronic health record data to determine whether any treatment events have occurred within the past ninety days (or other desired time frame). If a patient has been recently treated, it may be desirable to exclude that patient from monitoring at step 1214, because the patient may be already undergoing treatment and resulting data and compliance metrics may be erroneous or inaccurate. If the patient has not been recently treated, the patient may not have begun treatment and may be enrolled as a recurrent patient during step 1212.

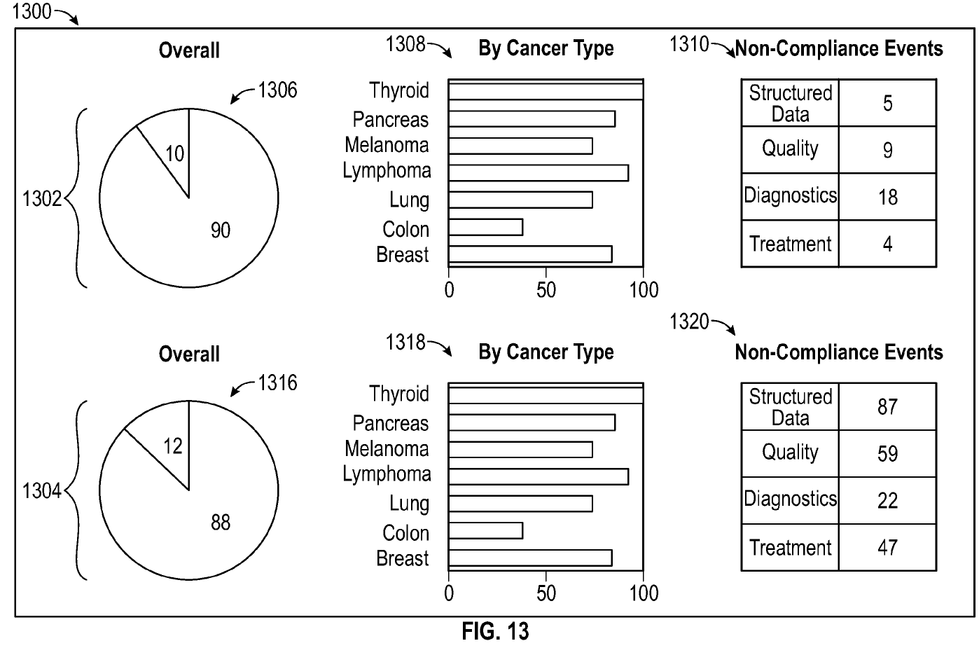

FIG. 13 illustrates an example user interface 1300 that a compliance module may generate for organizing and displaying compliance information customized for a particular medical practice. As shown in FIG. 13, user interface 1300 may include portions 1302 and 1304 that display practice-specific compliance data 1302 and compliance data 1304 for all practices enrolled in the medical home treatment system, respectively.

Interface portion 1302 may include graphs, tables, and/or other graphical elements that display practice-specific compliance data. Pie chart 1306 may illustrate the overall compliance performance of the medical practice (e.g., 10% non-complying events compared to 90% complying events). Compliance data may be organized based on disease type. For example, graph 1308 may display adherence computed as the number of adherent events for each cancer type divided by the total number of events for that cancer type (e.g., thyroid, pancreas, melanoma, lymphoma, lung, colon, and breast cancer). If desired, compliance data may be displayed in a table such as table 1310, which identifies types of events and how many non-compliant events have occurred at the medical practice for each type of event (e.g., five non-compliant structured data events, nine non-compliant quality events, eighteen non-compliant diagnostic events, and four non-compliant treatment events have occurred for the medical practice in the example of FIG. 13). If desired, portion 1302 may be more granular or broad in scope. For example, portion 1302 may be customized to display pathway adherence information for a particular medical practitioner, a set of medical practitioners sharing a specialty, or other subsets of the pathway adherence (compliance) information maintained by the compliance module.

Interface portion 1304 may include graphs, tables, and/or other graphical elements that include compliance data other than displayed in portion 1302. For example, portion 1304 may include general compliance data for all practices that are monitored by the compliance module. Graphs 1316, 1318, and 1320 may be produced similarly as graphs 1306, 1308, and 1310, but based instead on all available compliance data, which may help facilitate comparison and allows practices and/or individual physicians to see and address deficient areas of their practice.

The example of FIG. 13 in which portion 1304 displays compliance data for all practices is merely illustrative. It may be desirable for portion 1304 to display more specified or customized information for a particular practice. For example, portion 1304 may be customized to display compliance data for all practitioners at a given medical practice or office, or practitioners at one or more different offices, or practitioners with similar or different specialties.

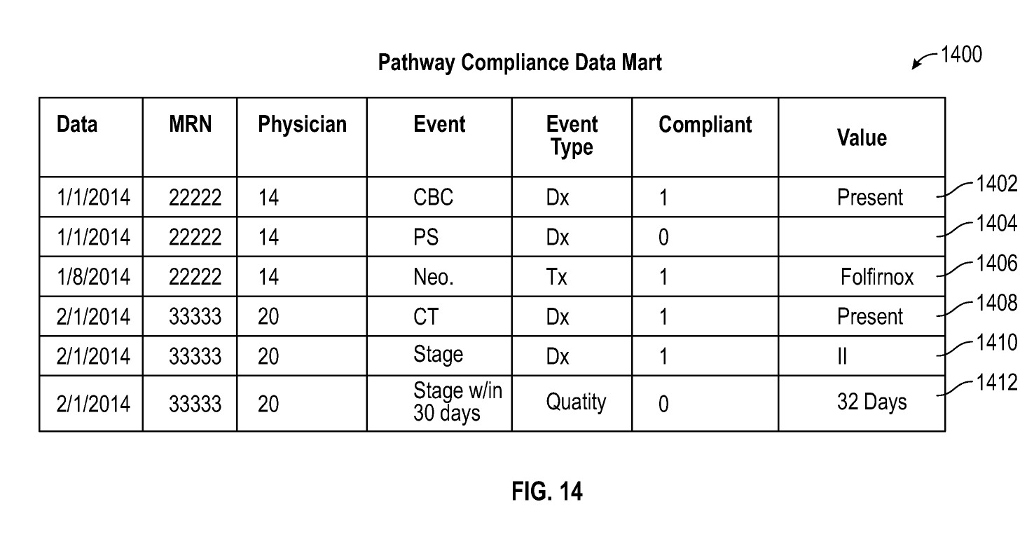

Pathway compliance data may be maintained as a database, table, or any desired data structure. The data structure may be maintained at a central computing system by a compliance module, and may be used in generating user interfaces or otherwise provided to medical practices. FIG. 14 illustrates an example pathway compliance table 1400 in which pathway compliance data may be maintained for a given medical practice (e.g., by a compliance module). Pathway compliance data structures such as table 1400 may sometimes be referred to as a data mart. As shown in FIG. 14, pathway compliance table 1400 may include entries such as entries 1402-1412. Each entry may include fields such as a date field, a patient identifier field that identifies patients by, for example, medical record number (MRN), and may include a physician identifier field, an event type field, a field identifying whether the medical practice was compliant with a desired clinical pathway and a value assigned to the event (e.g., assigned by processing retrieved data and metadata tags from an electronic health record maintained by the medical practice).

In the example of FIG. 14, entries 1402, 1404, and 1406 represent compliance data for a first patient identified by medical record number 22222. As indicated by entry 1402, a complete blood cell (CBC) diagnosis event (type Dx) was entered (value present) by physician 14 on Jan. 1, 2014 and is compliant (value 1) with a desired clinical pathway. Similarly, entry 1406 indicates that neoadjuvant therapy (Neo.) using the drug FOLFIRNOX was administered and is compliant. Entry 1404 indicates that a diagnostic event PS (performance status) has not yet been completed in compliance with the desired clinical pathway (compliant value 0). Entries 1408 and 1410 indicate that a second patient, identified by medical record number 33333, has had a computed tomography (CT) scan and cancer staging (stage II) in compliance with diagnosis events of a desired clinical pathway for the second patient. Entry 1412 may indicate that the cancer staging was performed thirty two days after the second patient's first visit to the medical practice, which is non-compliant with the 30-day quality event window required by the desired clinical pathway.

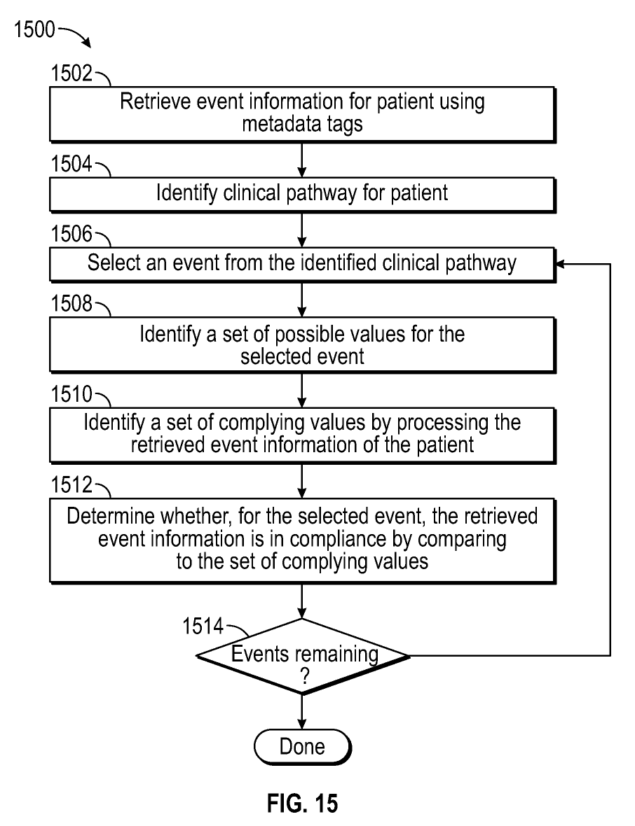

It may be desirable to adjust clinical pathways as events occur in the treatment and/or diagnosis of a patient. For example, clinical pathways may be optimized as more information such as diagnosis and treatment results is obtained. FIG. 15 illustrates a flowchart 1500 of steps that may be performed in adjusting a clinical pathway for a patient and determining pathway compliance/adherence. The steps of flowchart 1500 may be performed at central computing equipment by a compliance module (as an example), and may be performed in updating open events (e.g., during step 1116 of FIG. 11).

During step 1502, the compliance module may retrieve event information for the patient from an electronic health record. The event information may be retrieved based on metadata tags (e.g., by performing the steps of flowchart 1100 of FIG. 11).

During step 1504, the compliance module may identify a clinical pathway for the patient. For example, the compliance module may identify the clinical pathway including the events generated for the patient in steps 1110 and 1114 of flowchart 1100 of FIG. 11.

During step 1506, the compliance module may select an event from the identified clinical pathway that has not yet been completed (e.g., an open event). The compliance module may identify a set of possible values for the selected event during step 1508. For example, the compliance module may, for a treatment event, identify all possible treatments that could be performed. During subsequent step 1510, the compliance module may identify a set of complying values by processing the retrieved event information of the patient. In response to new information such as new diagnostic test results or treatment results, the compliance module may potentially identify a different set of complying values (e.g., a subset of the set of all possible event values). The desired clinical pathway may be updated with the subset of complying values. During step 1512, the compliance module may determine whether, for the selected event, the retrieved event information is in compliance with the updated treatment pathway. The retrieved event information may be compared to the subset of complying values to determine compliance for the selected event.

If events in the clinical pathway remain to be processed for optimization and compliance determination, the process may return to step 1506 at step 1514. If all events have been processed, the process may be complete.

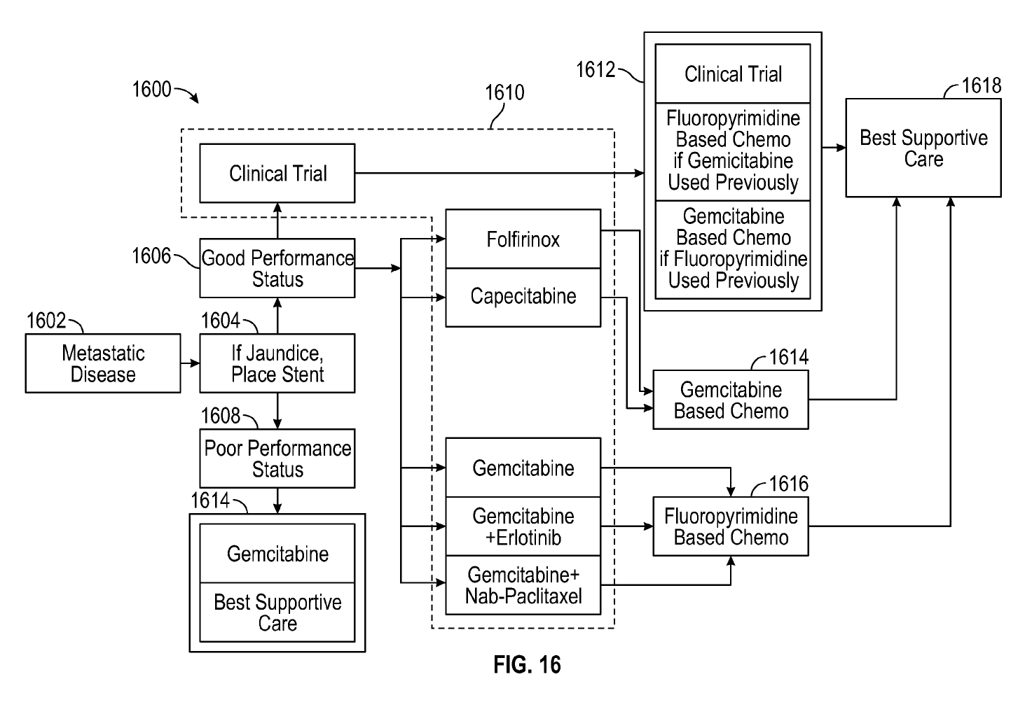

FIG. 16 is a flowchart 1600 of illustrative steps that may be performed in identifying a set of complying values for treatment events based on event information retrieved for a patient (e.g., from an electronic health record). The steps of flowchart 1600 may be performed during step 1510 of FIG. 15 by a compliance module.

During step 1602, the compliance module may process the retrieved event information to determine whether the patient has been diagnosed with a metastatic disease. If the patient has been diagnosed with a metastatic disease, the compliance module may process the retrieved event information to determine whether the patient has jaundice during subsequent step 1604. If the patient has jaundice, the clinical pathway for the patient may be adjusted to require a treatment event for placement of a stent (compliance with the stent requirement may be determined, for example, during step 1512 of FIG. 15).

If, at step 1606, the retrieved patient information indicates that the patient has a good or otherwise satisfactory performance status (e.g., the patient is in relatively good health), the process may determine a set of complying treatments 1610 that includes clinical trial, FOLFIRINOX, capecitabine, gemcitabine, gemcitabine and erlotnib, and gemcitabine and nab-Paclitaxel. In response to receiving event information identifying that the patient has received treatment, the compliance module may compare the received treatment to set 1610 to determine compliance (e.g., during step 1512 of FIG. 15). The treatment actually received by the patient may be used in determining what the next set of acceptable treatments is. For example, if the patient participated in a clinical trial, the compliance module may determine a subsequent set of complying treatments 1612 including clinical trial, fluoropyrimidine-based chemotherapy if gemcitabine was previously used in treating the patient, and gemcitabine-based chemotherapy if fluoropyrimidine was previously used in treating the patient. If the patient was treated with FOLFIRINOX or capecitabine, the only complying subsequent treatment is gemcitabine-based chemotherapy (set 1614). If the patient was treated with gemcitabine, gemcitabine and erlotinib, or gemcitabine and nab-Paclitaxel, the only complying subsequent treatment is fluoropyrimidine-based chemotherapy (set 1616). Subsequent to treatments complying with sets 1612, 1614, and 1616, the compliance module may determine that the only appropriate remaining treatment is supportive care (set 1618).

If the retrieved patient information indicates that the patient has a poor or otherwise unsatisfactory performance status during step 1608, the compliance module may determine that subsequent treatments should comply with set 1614 (gemcitabine or best supportive care).

Therefore, according to the above, some examples of the disclosure are directed to a method of using computing equipment to assist in medical treatment, the method comprising: with the computing equipment, retrieving electronic health record information from remote computing equipment associated with a medical practice and processing the electronic health record information to identify a patient; with the computing equipment, identifying a clinical pathway for the patient by processing the electronic health record information, wherein the clinical pathway comprises a sequence of events for treating the patient; and with the computing equipment, monitoring the remote computing equipment to determine whether the electronic health record information complies with the identified clinical pathway. Alternatively or additionally to one or more of the examples disclosed above, in some examples retrieving the electronic health record information from the remote computing equipment comprises receiving patient data containing metadata tags from the remote computing system and wherein the metadata tags are assigned to the events of the sequence of events. Alternatively or additionally to one or more of the examples disclosed above, in some examples the computing equipment comprises one or more processors and one or more memory modules that store instructions configuring the one or more processors to implement a data collection module and wherein retrieving the electronic health record information from the remote computing equipment comprises: with the data collection module, sending a request to the remote computing equipment; and with the data collection module, receiving the electronic health record information and the metadata tags from the remote computing equipment. Alternatively or additionally to one or more of the examples disclosed above, in some examples the instructions configure the one or more processors to further implement a compliance module and wherein processing the electronic health record information to identify the patient comprises: with the compliance module, processing the metadata tags to identify the patient as a new patient. Alternatively or additionally to one or more of the examples disclosed above, in some examples identifying the clinical pathway for the patient by processing the electronic health record information comprises: with the compliance module, generating a structured data event for the clinical pathway, wherein monitoring the remote computing equipment to determine whether the electronic health record information complies with the identified clinical pathway comprises: determining whether the electronic health record has been updated by the remote computing system with a predetermined type of patient information in compliance with the structured data event. Alternatively or additionally to one or more of the examples disclosed above, in some examples identifying the clinical pathway for the patient by processing the electronic health record information comprises: with the compliance module, generating a quality event that requires the electronic health record information to be updated with patient information identifying that an action has been taken for the patient within a given timeframe, wherein monitoring the remote computing equipment to determine whether the electronic health record information complies with the identified clinical pathway comprises: determining whether the electronic health record has been updated by the remote computing system with the patient information identifying that the action has been taken for the patient within the given timeframe. Alternatively or additionally to one or more of the examples disclosed above, in some examples identifying the clinical pathway for the patient by processing the electronic health record information comprises: with the compliance module, generating a diagnostic event that requires the electronic health record information to be updated with patient information identifying that a given diagnostic action has been taken on the patient, wherein monitoring the remote computing equipment to determine whether the electronic health record information complies with the identified clinical pathway comprises: determining whether the electronic health record has been updated by the remote computing system with the patient information identifying that the given diagnostic action has been taken on the patient. Alternatively or additionally to one or more of the examples disclosed above, in some examples identifying the clinical pathway for the patient by processing the electronic health record information comprises: processing the metadata tags to identify a prescribed treatment plan for the patient; and based on the prescribed treatment plan, generating at least one treatment event that requires the electronic health record information to be updated with patient information identifying that a given treatment action has been taken on the patient. Alternatively or additionally to one or more of the examples disclosed above, in some examples monitoring the remote computing equipment to determine whether the electronic health record information complies with the identified clinical pathway comprises: selecting an event from the identified clinical pathway; identifying a set of complying values by processing the electronic health record information; and comparing the set of complying values to the electronic health information to determine whether the electronic health record information complies with the selected event. Alternatively or additionally to one or more of the examples disclosed above, in some examples comparing the set of complying values to the electronic health information comprises comparing the set of complying values to a first portion of the electronic health information and wherein identifying the set of complying values by processing the electronic health record information comprises processing a second portion of the electronic health record to identify the set of complying values. Alternatively or additionally to one or more of the examples disclosed above, in some examples the selected event comprises a treatment event, wherein the second portion of the electronic health information identifies diagnostic information on the patient, and wherein processing the second portion of the electronic health record to identify the set of complying values comprises processing the diagnostic information to identify the set of complying values for the treatment event. Alternatively or additionally to one or more of the examples disclosed above, in some examples the remote computing equipment comprises an electronic health record system that maintains an electronic health record containing the electronic health record information, the method further comprising: with the computing equipment, processing the electronic health record information to generate the metadata tags; and with the computing equipment, assigning the metadata tags to portions of the electronic health record.

Some examples of the disclosure are directed to an apparatus for medical treatment, comprising: one or more computing systems, each computing system comprising: one or more memory modules storing one or more databases; and one or more processors, the one or more processors communicatively coupled to the one or more memory modules and capable of executing instructions stored in the one or more memory modules to implement a clinical pathway compliance system, wherein the clinical pathway compliance system retrieves information from an electronic health record at a remote computing system associated with a medical provider, processes the retrieved information to identify a clinical pathway, and compares the retrieved information to the clinical pathway to determine whether actions taken by the medical provider are in compliance with the clinical pathway. Alternatively or additionally to one or more of the examples disclosed above, in some examples the clinical pathway compliance system comprises: a data collection module that communicates with the remote computing system to retrieve the information from the electronic health record based on metadata tags in the electronic health record; and a compliance module that processes the retrieved information from the electronic health record to identify the clinical pathway and compares the retrieved information to the clinical pathway to determine whether actions taken by the medical provider are in compliance with the clinical pathway. Alternatively or additionally to one or more of the examples disclosed above, in some examples the clinical pathway comprises a sequence of events, wherein the compliance module comprises a rules engine that identifies sets of complying values for the sequence of events, and wherein the compliance module compares the retrieved information to the sets of complying values to determine whether the actions taken by the medical provider are in compliance with the clinical pathway. Alternatively or additionally to one or more of the examples disclosed above, in some examples the data collection module periodically retrieves updated information from the electronic health record of the remote computing equipment, wherein the rules engine processes the updated information to identify updated sets of complying values, and wherein the compliance module compares the updated information to the updated sets of complying values to determine whether new actions taken by the medical provider are in compliance with the clinical pathway. Alternatively or additionally to one or more of the examples disclosed above, in some examples the data collection module receives a report from the remote computing equipment that contains the information from the electronic health record and wherein the data collection module processes the report to extract only portions of the information that are associated with the metadata tags.

Some examples of the disclosure are directed to an apparatus for medical treatment, comprising: one or more computing systems, each computing system comprising: one or more memory modules; one or more processors, the one or more processors communicatively coupled to the one or more memory modules and capable of executing instructions stored in the one or more memory modules to implement an electronic health record system that maintains an electronic health record in the one or more memory modules and to implement an interface module that assigns metadata tags to fields in the electronic health record. Alternatively or additionally to one or more of the examples disclosed above, in some examples the interface module receives requests from a central computing system and processes the requests to retrieve information stored in the fields of the electronic health record that are assigned to the metadata tags. Alternatively or additionally to one or more of the examples disclosed above, in some examples the interface module maintains a database in the one or more memory modules and wherein the database includes entries that map metadata tags to respective electronic health record values.

Although examples of this disclosure have been fully described with reference to the accompanying drawings, it is to be noted that various changes and modifications will become apparent to those skilled in the art. Such changes and modifications are to be understood as being included within the scope of examples of this disclosure as defined by the appended claims.

1. A method of using computing equipment to assist in medical treatment, the method comprising:
with the computing equipment, retrieving electronic health record information from remote computing equipment associated with a medical practice and processing the electronic health record information to identify a patient;
with the computing equipment, identifying a clinical pathway for the patient by processing the electronic health record information, wherein the clinical pathway comprises a sequence of events for treating the patient; and
with the computing equipment, monitoring the remote computing equipment to determine whether the electronic health record information complies with the identified clinical pathway.

2. The method defined in claim 1 wherein retrieving the electronic health record information from the remote computing equipment comprises receiving patient data containing metadata tags from the remote computing system and wherein the metadata tags are assigned to the events of the sequence of events.

3. The method defined in claim 2 wherein the computing equipment comprises one or more processors and one or more memory modules that store instructions configuring the one or more processors to implement a data collection module and wherein retrieving the electronic health record information from the remote computing equipment comprises:
with the data collection module, sending a request to the remote computing equipment; and
with the data collection module, receiving the electronic health record information and the metadata tags from the remote computing equipment.

4. The method defined in claim 3 wherein the instructions configure the one or more processors to further implement a compliance module and wherein processing the electronic health record information to identify the patient comprises:
with the compliance module, processing the metadata tags to identify the patient as a new patient.

5. The method defined in claim 4 wherein identifying the clinical pathway for the patient by processing the electronic health record information comprises:
with the compliance module, generating a structured data event for the clinical pathway, wherein monitoring the remote computing equipment to determine whether the electronic health record information complies with the identified clinical pathway comprises:
determining whether the electronic health record has been updated by the remote computing system with a predetermined type of patient information in compliance with the structured data event.

6. The method defined in claim 4 wherein identifying the clinical pathway for the patient by processing the electronic health record information comprises:
with the compliance module, generating a quality event that requires the electronic health record information to be updated with patient information identifying that an action has been taken for the patient within a given timeframe, wherein monitoring the remote computing equipment to determine whether the electronic health record information complies with the identified clinical pathway comprises:
determining whether the electronic health record has been updated by the remote computing system with the patient information identifying that the action has been taken for the patient within the given timeframe.

7. The method defined in claim 4 wherein identifying the clinical pathway for the patient by processing the electronic health record information comprises:
with the compliance module, generating a diagnostic event that requires the electronic health record information to be updated with patient information identifying that a given diagnostic action has been taken on the patient, wherein monitoring the remote computing equipment to determine whether the electronic health record information complies with the identified clinical pathway comprises:
determining whether the electronic health record has been updated by the remote computing system with the patient information identifying that the given diagnostic action has been taken on the patient.

8. The method defined in claim 4 wherein identifying the clinical pathway for the patient by processing the electronic health record information comprises:
processing the metadata tags to identify a prescribed treatment plan for the patient; and
based on the prescribed treatment plan, generating at least one treatment event that requires the electronic health record information to be updated with patient information identifying that a given treatment action has been taken on the patient.

9. The method defined in claim 8 wherein monitoring the remote computing equipment to determine whether the electronic health record information complies with the identified clinical pathway comprises:
selecting an event from the identified clinical pathway;
identifying a set of complying values by processing the electronic health record information; and
comparing the set of complying values to the electronic health information to determine whether the electronic health record information complies with the selected event.

10. The method defined in claim 9 wherein comparing the set of complying values to the electronic health information comprises comparing the set of complying values to a first portion of the electronic health information and wherein identifying the set of complying values by processing the electronic health record information comprises processing a second portion of the electronic health record to identify the set of complying values.

11. The method defined in claim 10 wherein the selected event comprises a treatment event, wherein the second portion of the electronic health information identifies diagnostic information on the patient, and wherein processing the second portion of the electronic health record to identify the set of complying values comprises processing the diagnostic information to identify the set of complying values for the treatment event.

12. The method defined in claim 2 wherein the remote computing equipment comprises an electronic health record system that maintains an electronic health record containing the electronic health record information, the method further comprising:
with the computing equipment, processing the electronic health record information to generate the metadata tags; and
with the computing equipment, assigning the metadata tags to portions of the electronic health record.

13. An apparatus for medical treatment, comprising:
one or more computing systems, each computing system comprising:
one or more memory modules storing one or more databases; and
one or more processors, the one or more processors communicatively coupled to the one or more memory modules and capable of executing instructions stored in the one or more memory modules to implement a clinical pathway compliance system, wherein the clinical pathway compliance system retrieves information from an electronic health record at a remote computing system associated with a medical provider, processes the retrieved information to identify a clinical pathway, and compares the retrieved information to the clinical pathway to determine whether actions taken by the medical provider are in compliance with the clinical pathway.

14. The apparatus defined in claim 13 wherein the clinical pathway compliance system comprises:
a data collection module that communicates with the remote computing system to retrieve the information from the electronic health record based on metadata tags in the electronic health record; and
a compliance module that processes the retrieved information from the electronic health record to identify the clinical pathway and compares the retrieved information to the clinical pathway to determine whether actions taken by the medical provider are in compliance with the clinical pathway.

15. The apparatus defined in claim 14 wherein the clinical pathway comprises a sequence of events, wherein the compliance module comprises a rules engine that identifies sets of complying values for the sequence of events, and wherein the compliance module compares the retrieved information to the sets of complying values to determine whether the actions taken by the medical provider are in compliance with the clinical pathway.

16. The apparatus defined in claim 15 wherein the data collection module periodically retrieves updated information from the electronic health record of the remote computing equipment, wherein the rules engine processes the updated information to identify updated sets of complying values, and wherein the compliance module compares the updated information to the updated sets of complying values to determine whether new actions taken by the medical provider are in compliance with the clinical pathway.

17. The apparatus defined in claim 14 wherein the data collection module receives a report from the remote computing equipment that contains the information from the electronic health record and wherein the data collection module processes the report to extract only portions of the information that are associated with the metadata tags.

18. An apparatus for medical treatment, comprising:
one or more computing systems, each computing system comprising:
one or more memory modules;
one or more processors, the one or more processors communicatively coupled to the one or more memory modules and capable of executing instructions stored in the one or more memory modules to implement an electronic health record system that maintains an electronic health record in the one or more memory modules and to implement an interface module that assigns metadata tags to fields in the electronic health record.

19. The apparatus defined in claim 18 wherein the interface module receives requests from a central computing system and processes the requests to retrieve information stored in the fields of the electronic health record that are assigned to the metadata tags.

20. The apparatus defined in claim 19 wherein the interface module maintains a database in the one or more memory modules and wherein the database includes entries that map metadata tags to respective electronic health record values.
